(19) United States
(12) Patent Application Publication
(10) Pub. No.: US 2015/0182922 A1
(43) Pub. Date: Jul. 2, 2015

(54) AIR BLADE AND AIR-BLADE WHEEL

(71) Applicant: Huei-Wern TSUEI, Taipei City (TW)

(72) Inventor: Huei-Wern TSUEI, Taipei City (TW)

(21) Appl. No.: 14/583,809

(22) Filed: Dec. 29, 2014

(30) Foreign Application Priority Data
Dec. 30, 2013 (TW) 102149171

(51) Int. Cl. B01F 3/04; A01K 63/04

(52) U.S. Cl. CPC B01F 3/04539; A01K 63/042; B01F 2003/04567

(57) ABSTRACT

An air blade is provided. The air blade includes a body, an airflow channel and an anti-resistance structure. The body has a central axis. The airflow channel is located on one side of the body, and is parallel to the central axis of the body. The anti-resistance structure is located on the other side of the body, and corresponds to the airflow channel.

### RELATED APPLICATIONS

This application claims priority to Taiwan Application Serial Number 102149171, filed Dec. 30, 2013, which is herein incorporated by reference.

### BACKGROUND

1. Technical Field

The present disclosure relates to an air blade and an air-blade wheel. More particularly, the present disclosure relates to an air blade and an air-blade wheel applied to the air-increased waterwheel for fishery.

2. Description of Related Art

In the conventional fishery, the air-increased waterwheel or vane wheel aerator is applied to the fish farm. The conventional waterwheel has paddle blade with a plurality of holes, wherein the paddle blade is driven from the water plane into the water, and then driven outwardly from the water. However, the paddle blade is board-shaped with multiple holes, so that the resistance is excessive when the paddle blade is driven from the water plane into the water or outwardly from the water, and would consume excessive energy.

### SUMMARY

According to one aspect of the present disclosure, an air blade includes a body, an airflow channel and an anti-resistance structure. The body has a central axis. The airflow channel is located on one side of the body, and parallel to the central axis of the body. The anti-resistance structure is located on the other side of the body, and corresponding to the airflow channel.

According to another aspect of the present disclosure, an air-blade wheel includes at least one wheel plate and a plurality of air blades Each of the air blades connected to one side of the wheel plate. Each of the air blades includes a body, an airflow channel and an anti-resistance structure. The body has a central axis. The airflow channel is located on one side of the body, and parallel to the central axis of the body. The anti-resistance structure is located on the other side of the body, and corresponding to the airflow channel.

### BRIEF DESCRIPTION OF THE DRAWINGS

FIG. 1A shows a schematic view of an air blade according to one embodiment of the present disclosure;

FIG. 1B shows a sectional view of the air blade along line 1B-1B of FIG. 1A;

FIG. 2 shows a schematic view of one using state of the air blade 100 of FIG. 1;

FIG. 3 shows a sectional views of an air blade according to another embodiment of the present disclosure;

FIG. 4 shows a sectional views of an air blade according to further another embodiment of the present disclosure;

FIG. 5A shows a schematic view of an air blade according to another embodiment of the present disclosure;

FIG. 5B shows a schematic view of a spacer of the air blade of FIG. 5A;

FIG. 6 shows a schematic view of an air blade according to further another embodiment of the present disclosure;

FIG. 7 shows a schematic view of an air-blade wheel according to yet another embodiment of the present disclosure;

FIG. 8 shows a side view of the air-blade wheel of FIG. 7;

FIG. 9 shows a schematic view of the air-blade wheel of FIG. 7;

FIG. 10 shows a schematic view of an air-blade wheel according to still another embodiment of the present disclosure;

FIG. 11 shows a schematic view of the wheel plates and the air blades of FIG. 10;

FIG. 12 shows a schematic view of wheel plates and air blades according to further embodiment of the present disclosure;

FIG. 13 shows a schematic view of an air-blade wheel according to yet another embodiment of the present disclosure; and

FIG. 14 shows a schematic view of an air-blade wheel according to still another embodiment of the present disclosure.

### DETAILED DESCRIPTION

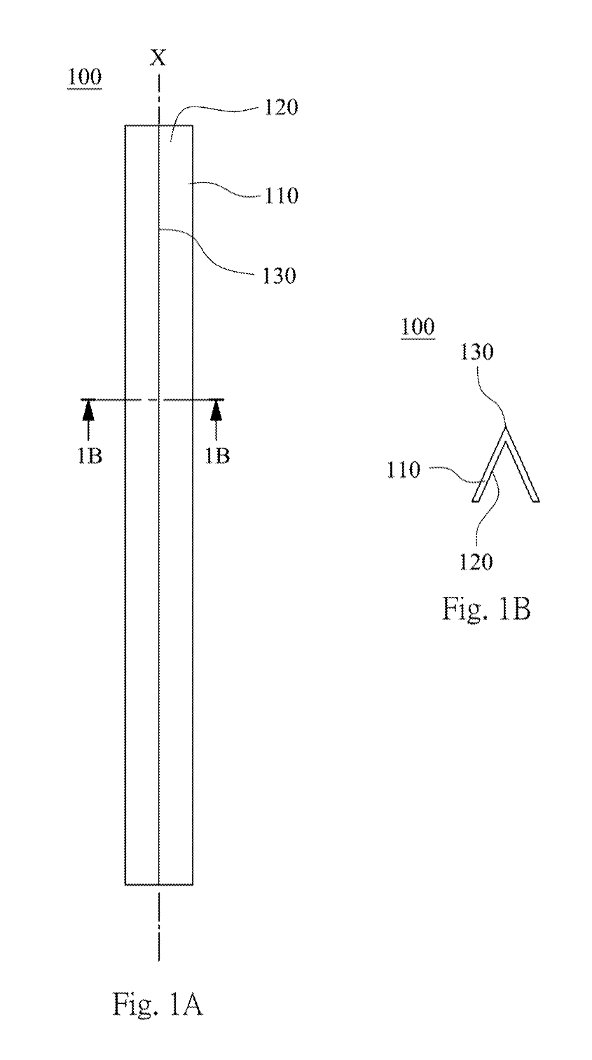

FIG. 1A shows a schematic view of an air blade 100 according to one embodiment of the present disclosure. FIG. 1B shows a sectional view of the air blade 100 along line 1B-1B of FIG. 1A. In FIGS. 1A and 1B, the air blade 100 includes the body 110, an airflow channel 120 and an anti-resistance structure 130.

The body 110 being column-shaped has a central axis X.

The airflow channel 120 is located on one side of the body 110, and is parallel to the central axis X of the body 110. In FIG. 1B, the airflow channel 120 in this embodiment is V-shaped channel. That is, one side of the body 110 is formed into V-shaped channel, the other side is relatively formed a V-shaped (sharp-shaped) protruding.

The V-shaped (sharp-shaped) protruding is the anti-resistance structure 130, in this embodiment, the airflow channel 120 is V-shaped channel. Accordingly, the anti-resistance structure 130 is sharp-shaped (V-shaped) protruding.

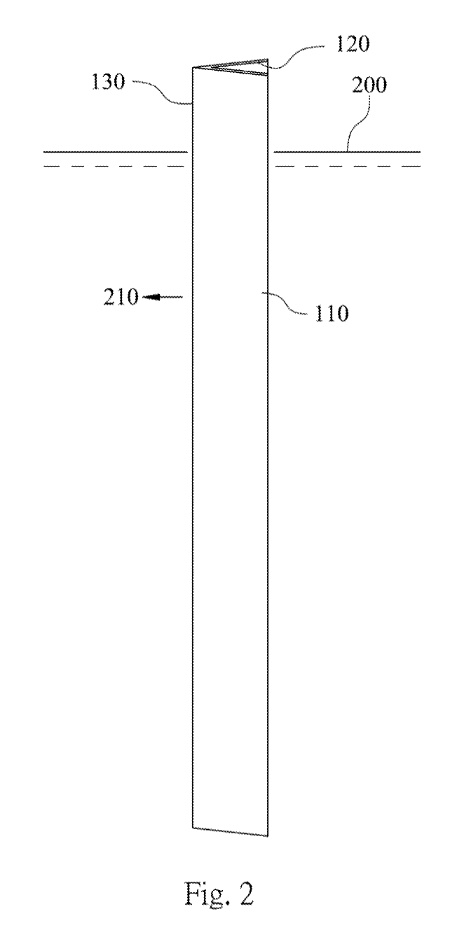

FIG. 2 shows a schematic view of one using state of the air blade 100 of FIG. 1. In FIG. 2, the air blade 100 is vertically and partially located in the water, so that the air blade 100 is perpendicular to the horizontal plane 200 of the water. When the air blade 100 is moved in the water along the direction 210, the anti-resistance structure 130 can eliminate the water against the resistance in the water, and the air can be lead into the water from the partial airflow channel 120 which is exposed from the horizontal plane 200 of the water. Therefore the oxygen content of the water can be increased by the efficient and energy conservative way.

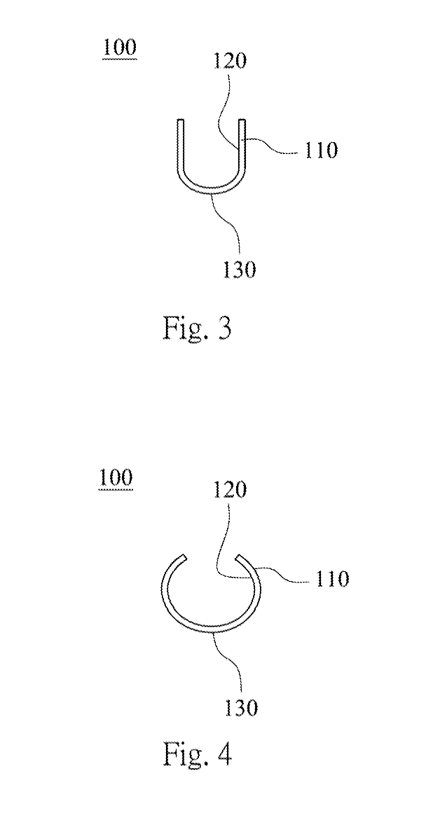

FIGS. 3 and 4 show two sectional views of air blades 100 according to other embodiments of the present disclosure, In FIG. 3, the airflow channel 120 of the air blade 100 is U-shaped, and the anti-resistance structure 130 of the air blade 100 is curve-shaped accordingly. In FIG. 4, the airflow channel 120 of the air blade 100 is C-shaped, and the anti-resistance structure 130 of the air blade 100 is curve-shaped accordingly. Hence, the curve-shaped anti-resistance structure 130 being streamlined shape can eliminate the water stably, and the U-shaped or C-shaped airflow channel 120 can lead the air into the water for increasing the oxygen content of the water.

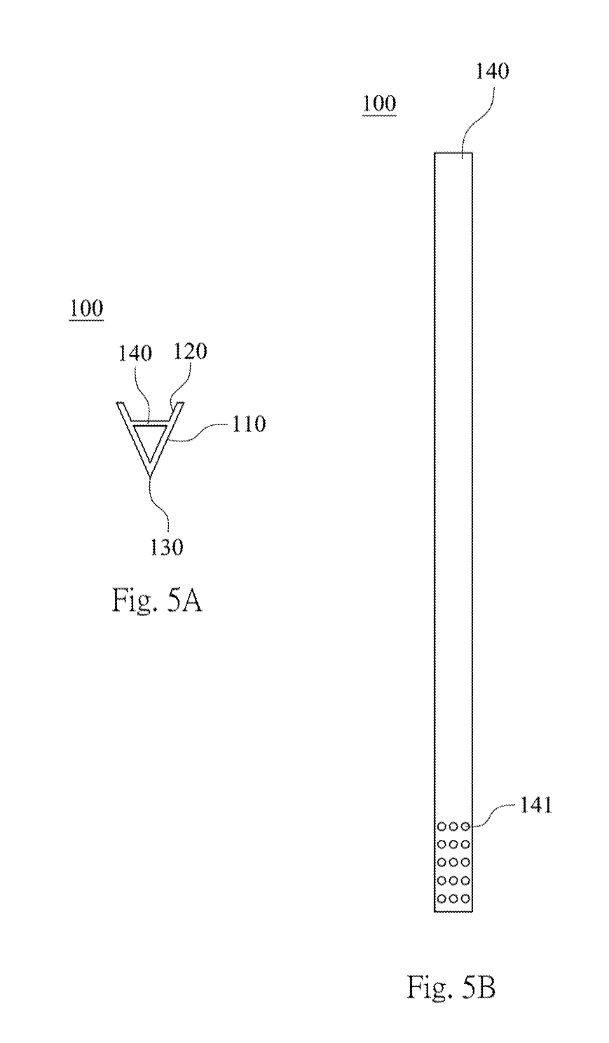

FIG. 5A shows a schematic view of an air blade 100 according to another embodiment of the present disclosure. FIG. 5B shows a schematic view of a spacer 140 of the air blade 100 of FIG. 5A. In FIGS. 5A and 5B, the air blade 100 can further include the spacer 140 disposed in the airflow channel 120 along the central axis X of the body 110, wherein two side ends of the spacer 140 are connected to two inner sides of the airflow channel 120 respectively. Therefore, the airflow channel 120 can be separated into two portions by the spacer 140. Since the air blade 100 with longer size is applied to the deep-water zone, the air can be led into the water along the portion of the airflow channel 120 which is covered by the spacer, and would not affected by the water flow. Therefore,, the oxygen content of the water can be increased effectively. Moreover, the spacer 140 can be integrally formed with the body 100 (shown in FIG. 5A), or detachably connected to the body 100. When the spacer 140 is detachably connected to the body 100, the spacer 140 can be assembled to or removed from the body 100, so that the application of the air blade 100 is wider.

Furthermore, the spacer 140 can include a plurality of through holes 141, which are located on the lower portion of the spacer 140, wherein the lower portion of the spacer 140 represents the portion of the spacer 140 which is under the horizontal plane 200 of the water in use. Hence, the air can be led along the airflow channel which is covered by the spacer 140 and passes through the through holes 141 of the spacer 140 into the deep water. The user can change the size, number and arrangement of the through holes 141 on demand, and will not be limited to the embodiment of FIG. 5B.

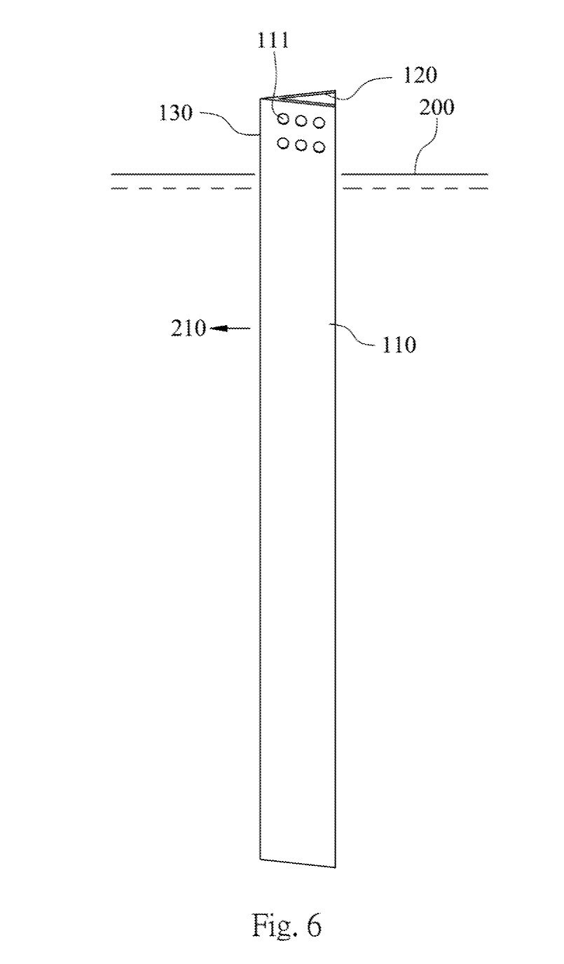

FIG. 6 shows a schematic view of an air blade 100 according to further another embodiment of the present disclosure. In FIG. 6, the body 110 of the air blade 100 can include a plurality of through holes 111, wherein the through holes 111 can be located on the higher portion or the lower portion of the body 110. The higher portion of the body 110 represents the portion of the body 110 which is exposed from the horizontal plane 200 of the water n use; the lower portion of the body 110 represents the portion of the body 110 which is under the horizontal plane 200 of the water in use. When the through holes 111 are located on the higher portion of the body 110, the amount of the air into the airflow channel 120 can be increased, and the efficiency of the air blade 100 can be enhanced. When the through holes 111 are located on the lower portion of the body 100, the diffusion rate of the air from the airflow channel 120 into the water can be increased. The user can change the size, number and arrangement of the through holes 111 on demand, and will not be limited to the embodiment of FIG. 6.

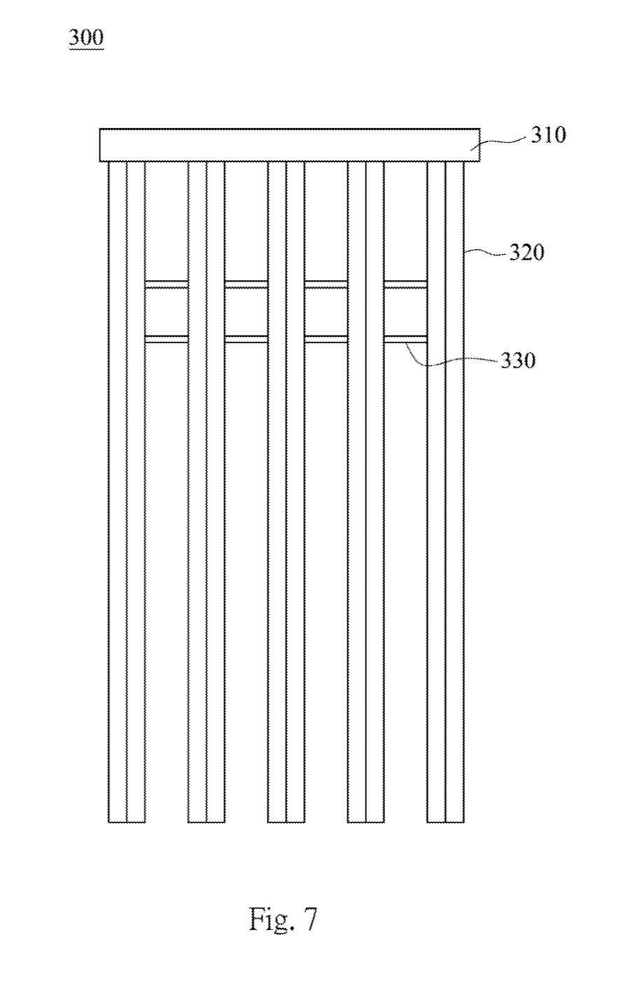

FIG. 7 shows a schematic view of an air-blade wheel 300 according to yet another embodiment of the present disclosure. The air-blade wheel 300 includes a wheel plate 310 and a plurality of air blades 320.

In FIG. 7, each of the air blades 320 is connected to one side of the wheel plate 310, and each air blade 320 is identical to the air blade 100 in FIGS. 1A and 1B, and will not describe again herein. In detail, the air blades are straight arranged on the wheel plate, distances between each two air blades which are adjacent to each other are the same. Therefore, the wheel plate 310 of the air-blade wheel 300 can be applied to general air-increased waterwheel or aerator as the blade thereof, and can be driven for moving the air blades in the water, so that the air can be led into the water equally.

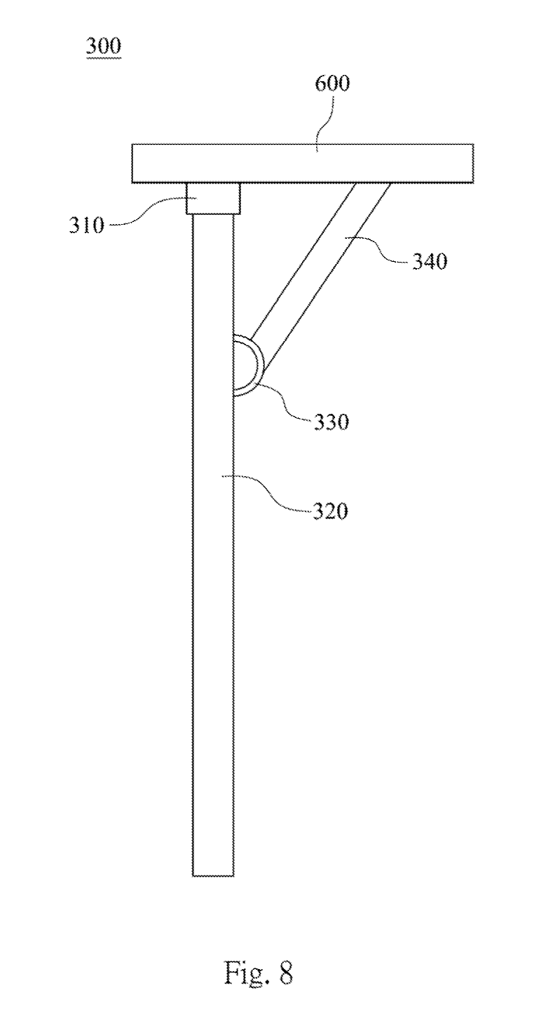

FIG. 8 shows a side view of the air-blade wheel 300 of FIG. 7. According to the embodiment of FIG. 8, the air-blade wheel 300 can further include a baffle plate 330 and a supporting member 340, wherein the baffle plate 330 is connected to one side of each of the air blades, and the supporting member 340 is connected to the baffle plate 330. Hence, the air blades 320 can be further positioned, and one end of the supporting member 340 is connected to the baffle plate 330, the other end of the supporting member 340 can be connected to an operating member 600 of the aerator which is applied by the air-blade wheel 300. The operation of the air-blade wheel 300 can be more stable by the baffle plate 330 and the supporting member 340.

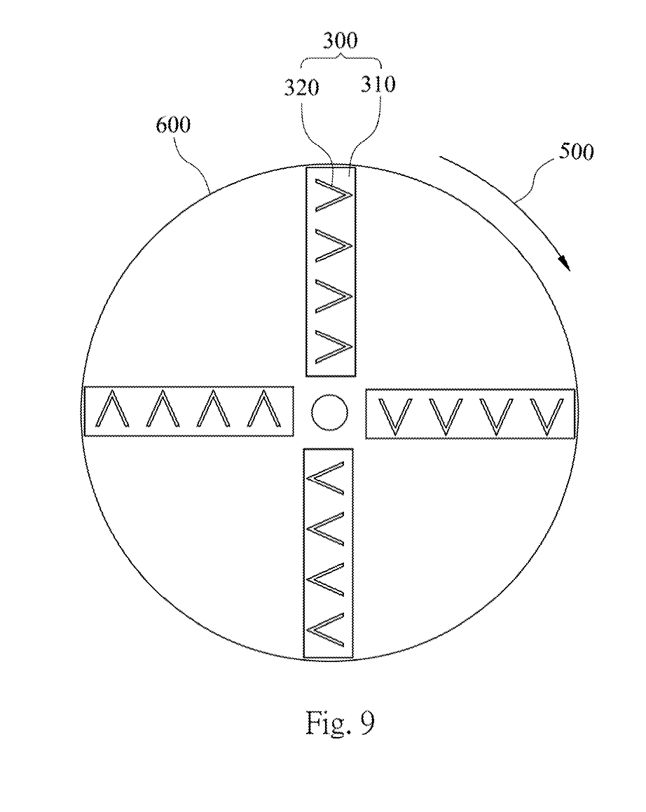

FIG. 9 shows a schematic view of the air-blade wheel 300 of FIG. 7, wherein the air-blade wheel 300 is applied to an aerator. In FIG. 9, when the operating member 600 of the aerator is disk-shaped, the air-blade wheel 300 can be disposed thereon, and the number of the air-blade wheel 300 can be adjusted on demand, so that the expected air quantity and efficiency can be reached. In FIG. 9, there are four air-blade wheels 300 applied to the operating member 600 of the aerator, and will not be limited thereof. The air-blade wheels 300 also can be applied to others aerator, and will not be limited to the applications of FIGS. 8 and 9.

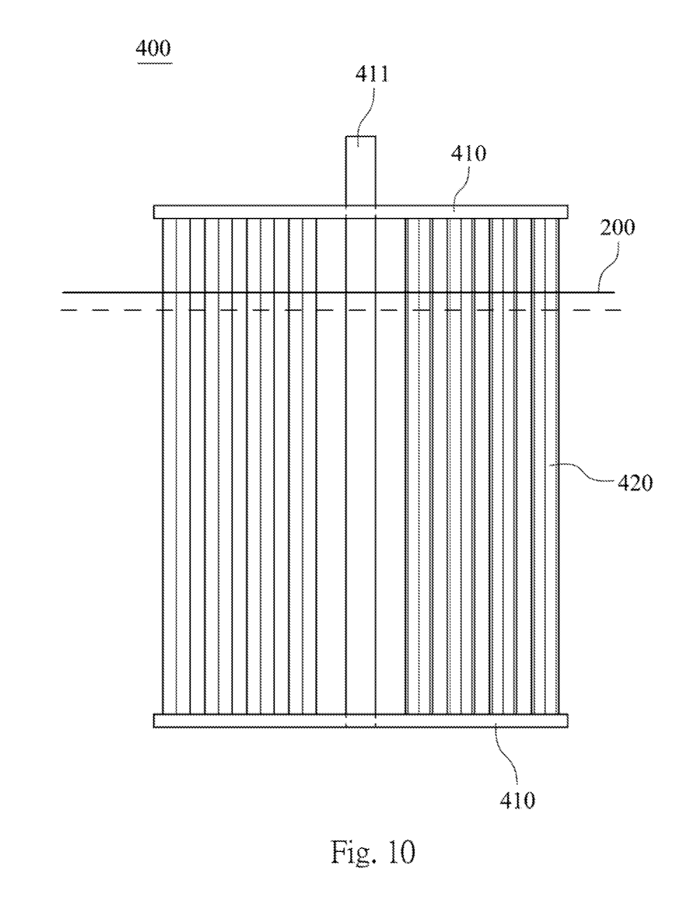

FIG. 10 shows a schematic view of an air-blade wheel 400 according to still another embodiment of the present disclosure. In FIG. 10, the air-blade wheel 400 includes two wheel plates 410, a driving axis 411 and a plurality of air blades 420. The driving axis 411 is coaxially connected through the two wheel plates 410, two ends of each of the air blades 420 are connected to the two wheel plates 410 respectively, and the central axis of the body of each of the air blades 420 is parallel to the driving axis 411. Therefore, the driving axis 411 can be driven by external driving force for stably linking up with the air-blade wheel due to the connection with the two wheel plates 410.

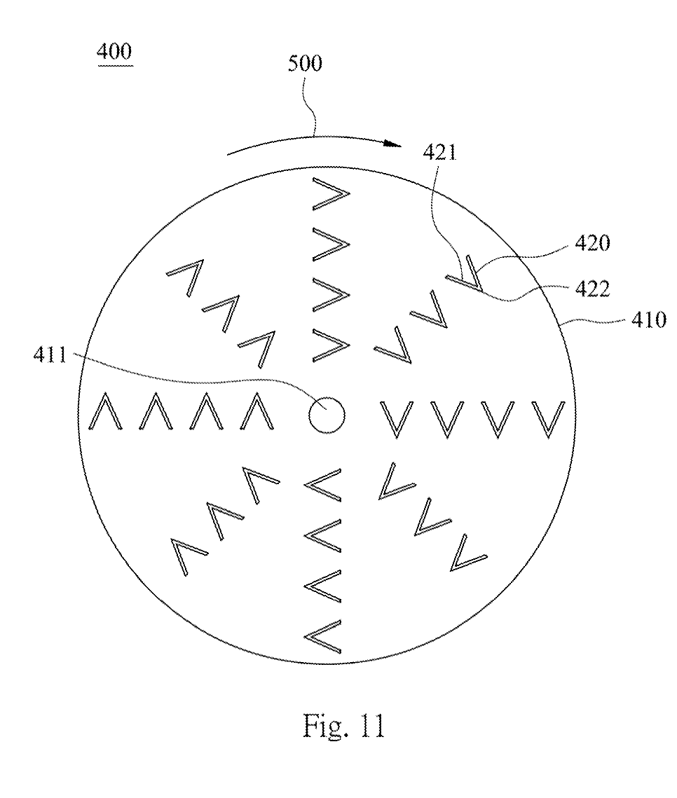

FIG. 11 shows a schematic view of the wheel plates 410 and the air blades 420 of FIG. 10. In this embodiment, the two wheel plates 410 are disk-shaped, the air blades 420 are connected to the wheel plates 410 along a direction of at least one diameter which is passed through a center of each of the wheel plates 410, and the airflow channel 421 of each of the air blades 420 is disposed toward a rotating direction 500 of the wheel plates 410. In FIG. 9, partial of the air-blade wheel 400 is in the water, so that the anti-resistance structure 422 of the air blades 420 can eliminate the water against the resistance in the water, and the air can be lead into the water from the partial airflow channel 421 of the air blades 420 which are exposed from the horizontal plane 200 of the water when the wheel plates 410 and the air blades 420 are linked up with the driving axis 411. Hence, the oxygen content of the water can be increased.

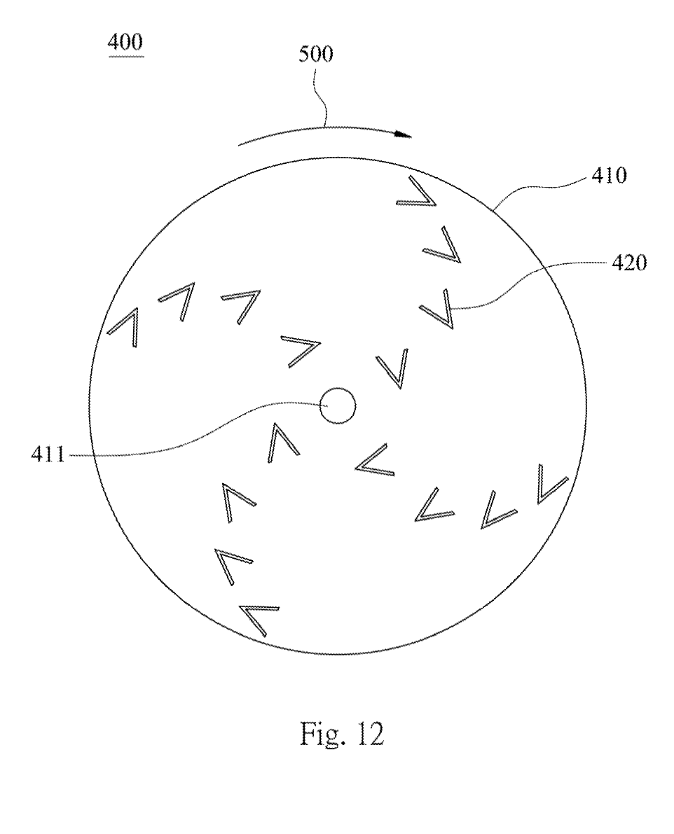

FIG. 12 shows a schematic view of wheel plates 410 and air blades 420 according to further embodiment of the present disclosure. In FIG. 12, the air blades 420 are swirly arranged from a center of each of the wheel plates 410 to a periphery of each of the wheel plates 410. Further, a distance between any two air blades 420 which are adjacent to each other is gradually shortened from the center of each of the wheel plates 410 to the periphery of each of the wheel plates 410. That is, the arrangement of the air blades 420 changes from sparse in the center of each of the wheel plates 410 to dense in the periphery of each of the wheel plates 410. Therefore, the air-increased efficiency of the periphery of each of the wheel plates 410 can be enhanced so as to reach the high efficiency and low energy dissipation.

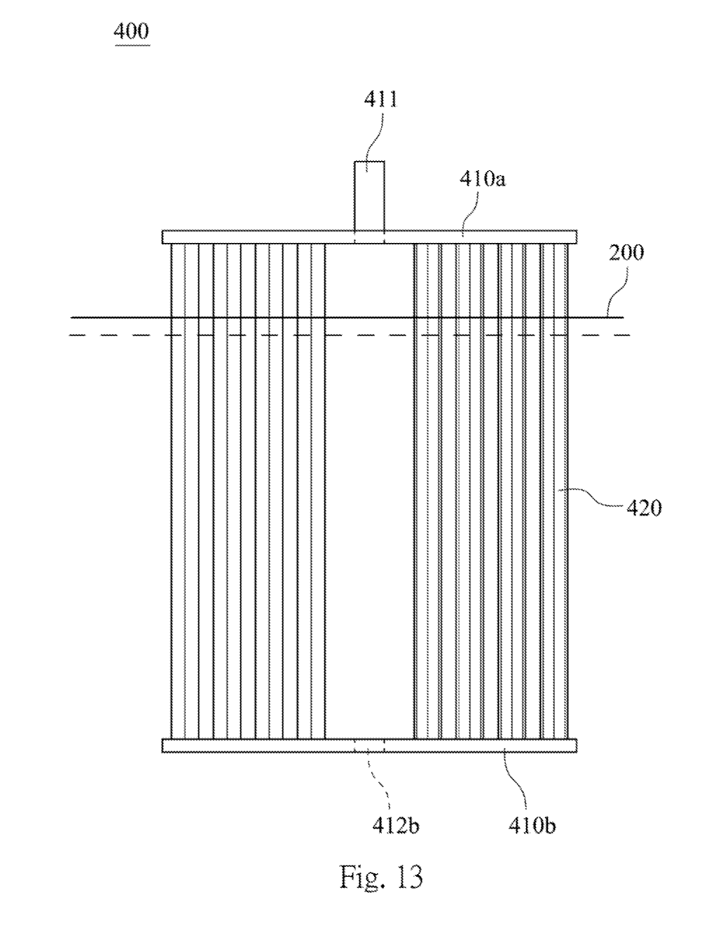

FIG. 13 shows a schematic view of an air-blade wheel 400 according to yet another embodiment of the present disclosure. In FIG. 13, the air-blade wheel 400 includes a first wheel plate 410a, a second wheel plate 410b, a driving axis 411 and a plurality of air blades 420. In detail, the driving axis 411 is coaxially connected to the first wheel plate 410a two ends of each of the air blades 420 are connected to the first wheel plate 410a and the second wheel plate 410b respectively, and the central axis of the body (not be labeled) of each of the air blades 420 is parallel to the driving axis 411. Furthermore, the second wheel plate 410b includes an opening 412b located on a center thereof. When the first wheel plate 410a is driven by the driving axis 411 and links up with the air blades 420 and the second wheel plate 410b which is in the water, the water flow would be driven as vortex, and the water flow can be exhausted from the opening 412b of the second wheel plate 410b. Therefore, the air-blade wheel 400 can be driven smoothly.

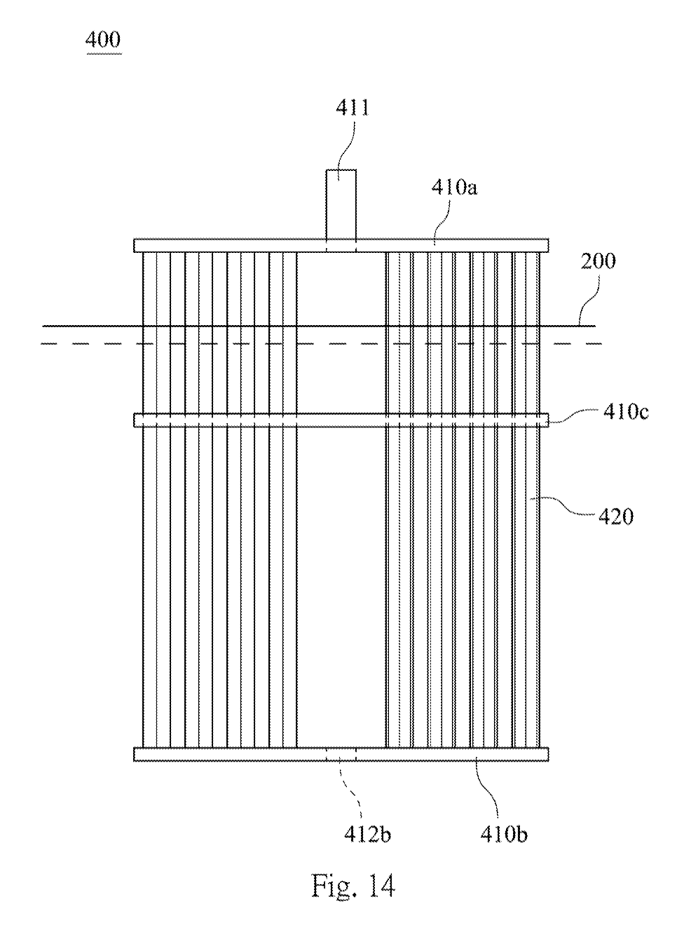

FIG. 14 shows a schematic view of an air-blade wheel 400 according to still another embodiment of the present disclosure. In FIG. 14, the number of wheel plate is three, which are a first wheel plate 410a, a second wheel plate 410b and a third wheel plate 410c, wherein the third wheel plate 410c is located between the first wheel plate 410a and the second wheel plate 410b, and each of the air blades 420 is connected through the third wheel plate 410c. Therefore, the air blades 420 can be firmly positioned between the first wheel plate 410a and the second wheel plate 410b by the third wheel plate 410c. When the size of the air-blade wheel 400 is longer and is applied in the deeper water, the operation of the air-blade wheel 400 can be stable, and the working life thereof can be extended.

According to the air-blade wheel 300, 400 of FIGS. 9-14, the rotating direction 500 of the air-blade wheel 300, 400 is parallel to the horizontal plane 200, so that the water splash can be avoided during operation. Furthermore, the air-blade wheel 300, 400 can continuously lead the air into the water during operatic wherein the air-blade wheel 300, 400 provides double efficiency or more than double efficiency of the conventional air-increased waterwheel (or aerator). That is, the low energy dissipation can also be reached.

The air blade 100 in FIGS. 1-6 can be applied to the air-blade wheel of FIGS. 7-14, and will not be limited to the embodiments in the present disclosure. Moreover, the air-blade wheel of FIGS. 7-14 can be applied to the general air-increased waterwheel or aerator, and will not describe herein.

The foregoing air blade and air-blade wheel have the advantages and efficiency as follow.

1. The air blade of the present disclosure has the airflow channel and the anti-resistance structure which are relatively disposed on two side of the body. Therefore, the anti-resistance structure can eliminate the water against the resistance in the water, and then the air can be lead into the water along the airflow channel.

2. The air-blade wheel is cooperated with the foregoing air blades which can be equally arranged, so that the air can be led into the water stably. Further, the arrangement of the air blades changes from sparse in the center of each of the wheel plates to dense in the periphery of each of the wheel plate so that the amount of the air into the water can be increased.

3. When the air-blade wheel is operated, part of the air-blade wheel is on the water, and the other part of the air-blade wheel is in the water. Hence, the air-blade wheel can continuously lead the air into the water during operation.

4. The body or the spacer of the air blade can further include through holes, respectively. When the through holes are located on the higher portion of the body, the amount of the air into the airflow channel can be increased. When the through holes are located on the lower portion of the body or the spacer, the diffusion rate of the air from the airflow channel into the water can be increased.

It will be apparent to those skilled in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. An air blade, comprising:
a body having a central axis;
an airflow channel located on one side of the body, and parallel to the central axis of the body; and
an anti-resistance structure located on the other side of the body, and corresponding to the airflow channel.

2. The air blade of claim 1, wherein the airflow channel is V-shaped, U-shaped or C-shaped.

3. The air blade of claim 1, wherein the anti-resistance structure is sharp-shaped or curve-shaped.

4. The air blade of claim 1, further comprising:
a spacer disposed in the airflow channel along the central axis of the body, wherein two side ends of the spacer are connected to two inner sides of the airflow channel respectively.

5. The air blade of claim 4, wherein the spacer comprises a plurality of through holes.

6. The air blade of claim 1, wherein the body comprises a plurality of through holes.

7. Art air-blade wheel, comprising:
at least one wheel plate; and
a plurality of air blades, each of the air blades connected to one side of the wheel plate, wherein each of the air blades comprises:
a body having a central axis;
an airflow channel located on one side of the body, and parallel to the central axis of the body; and
an anti-resistance structure located on the other side of the body, and is relative to the airflow channel.

8. The air-blade wheel of claim 7, wherein a number of wheel plate is two, which are a first wheel plate and a second wheel plate, and the air-blade wheel further comprises:
a driving axis coaxially connected to the first wheel plate, two ends of each of the air blades are connected to the first wheel plate and the second wheel plate respectively, and the central axis of the body of each of the air blades is parallel to the driving axis.

9. The air-blade wheel of claim 8, wherein the second wheel plate comprises an opening located on a center thereof.

10. The air-blade wheel of claim 8, wherein the number of wheel plate is three, which are the first wheel plate, the second wheel plate and a third wheel plate, the third wheel plate is located between the first wheel plate and the second wheel plate, and each of the air blades is connected through the third wheel plate.

11. The air-blade wheel of claim 7, wherein a number of wheel plate is two, and the air-blade wheel further comprises:
a driving axis coaxially connected through the two wheel plates, two ends of each of the air blades are connected to the two wheel plates respectively, and the central axis of the body of each of the air blades is parallel to the driving axis.

12. The air-blade wheel of claim 11, wherein each of the wheel plates is disk-shaped, the air blades are connected to the wheel plates along a direction of at least one diameter which is passed through a center of each of the wheel plates, and the airflow channel of each of the air blades is disposed toward a rotating direction of the wheel plates.

13. The air-blade wheel of claim 11, wherein each of the wheel plates is disk-shaped, and the air blades are swirly arranged from a center of each of the wheel plates to a periphery of each of the wheel plates.

14. The air-blade wheel of claim 13, wherein a distance between any two air blades which are adjacent to each other is gradually shortened from the center of each of the wheel plates to the periphery of each of the wheel plates.

15. The air-blade wheel of claim 7, wherein the air blades are straight arranged on the wheel plate, distances between each two air blades which are adjacent to each other are the same.

16. The air-blade wheel of claim 15, further comprising:
a baffle plate connected to one side of each of the air blades.

17. The air-blade wheel of claim 16, further comprising:
a supporting member connected to the baffle plate for positioning the baffle plate and the air blades.

18. The air-blade wheel of claim 7, wherein each of the air blades further comprises:
a spacer disposed in the airflow channel along the central axis of the body, wherein two side ends of the spacer are connected to two inner sides of the airflow channel respectively,

19. The air blade of claim 18, wherein the spacer comprises a plurality of through holes.

20. The air blade of claim 7, wherein the body of each of the air blades comprises a plurality of through holes.
